(19) United States
(12) Patent Application Publication
(10) Pub. No.: US 2013/0074881 A1
(43) Pub. Date: Mar. 28, 2013

(54) PROCESS FOR PICKLING OR DESCALING A CONCRETE SURFACE

(71) Applicants: Jacques Quintard, Presles (FR); Frederic Richard, Parmain (FR); Charles Truchot, Saint Nazaire (FR)

(72) Inventors: Jacques Quintard, Presles (FR); Frederic Richard, Parmain (FR); Charles Truchot, Saint Nazaire (FR)

(73) Assignee: L'Air Liquide Societe Anonyme Pour I'Etude et I'Expoitation des Procedes Georges Claude, Paris (FR)

(21) Appl. No.: 13/701,618

(22) PCT Filed: May 9, 2011
(86) PCT No.: PCT/FR2011/051037

§ 371 Date: Dec. 3, 2012

(30) Foreign Application Priority Data
Jun. 3, 2010 (FR) 1054345

(51) Int. Cl. B08B 7/00

(52) U.S. Cl. CPC B08B 7/0021
USPC 134/34

(57) ABSTRACT

A method for pickling or descaling a concrete surface employing at least one jet of liquid nitrogen at cryogenic temperature below −100° C. at a pressure of at least 500 bar, distributed by the discharge orifice of at least one nozzle for distributing the jet of liquid nitrogen. At least a portion of the distributing nozzle is protected by a resistant material haying a hardness of at least 7 on Mohs' scale. Preferably, the resistant material is deposited externally on at least a portion of wall of nozzle. Advantageously, the material is selected from tungsten carbide, boron carbide, titanium carbide, silicon carbide, cubic boron nitride, alumina and corundum.

The invention relates to a method for pickling or descaling a concrete surface employing one or more jets of nitrogen at cryogenic temperature and at high pressure, in particular of liquid nitrogen under pressure.

It is known that it is possible to use one or more jets of liquid nitrogen for pickling or descaling certain surfaces or coatings. During such an operation, three effects of each jet of liquid nitrogen are combined, namely:
the mechanical effect of the jet, i.e. the impact of the pressure of liquid nitrogen on the substrate,
the cryogenic effect of nitrogen in the liquid state, i.e. at a cryogenic temperature typically below −160° C.,
the effect of “swelling” or the effect of “blowing” (“blast effect”) produced by rapid heating of the liquid nitrogen in contact with the ambient air with transition from the liquid phase to the gas phase, which occupies more volume. Thus, 1 liter of liquid nitrogen vaporizes to give 700 liters of gaseous nitrogen.

In certain applications, such as descaling of concrete, it is mainly the “blast effect” of liquid nitrogen that comes into action for executing the work that is required.

In this case, each jet of liquid nitrogen “explodes” the concrete surface and propels the constituents of the concrete in all directions.

Now, it is found in practice that after a variable time in use, for example after some hours of use, the descaling devices used for distributing the liquid nitrogen become less efficient.

After investigation, it was found that their loss of efficiency is due to wear of the nozzles 1 for distributing the liquid nitrogen with which these descaling devices are equipped, as shown in FIG. 6.

In fact, the constituents of the concrete that are detached by the nitrogen jets 10 strike the nozzle or nozzles 1 for distributing the jets of liquid nitrogen, causing premature erosion of them.

In other words, the stripped concrete that is detached from the substrate under the action of the jet or jets of liquid nitrogen will cause deterioration of the nozzles, which are generally made of stainless steel, typically a stainless steel of grade 316.

In fact, the present inventors have demonstrated that premature wear of the liquid. nitrogen distributing nozzles is the direct cause of the gradual loss of efficiency of the methods of pickling or descaling, since a degraded nozzle ejects a jet of liquid nitrogen that is noncoherent and dispersed, and therefore less effective.

An obvious solution would be to replace the eroded nozzle or nozzles.

Now, a frequent need to replace the nozzles of a device for pickling or descaling concrete gives rise to a significant cost and a loss of productivity during the phases of replacement and maintenance of the nozzles of the device.

Moreover, said nozzle replacement is not always easily achieved, notably when the operation of concrete pickling or descaling takes place in an environment where human intervention is very limited, or even forbidden, and where preventive maintenance must be as limited and as quick as possible, such as in certain chemical or nuclear vessels.

Thus, the problem to be solved is to be able to avoid the drop in efficiency of methods for pickling or descaling concrete, without the necessity of frequent replacement of the nozzles of the pickling or descaling device employed.

The solution is a method for pickling or descaling a concrete surface employing at least one jet of liquid nitrogen at cryogenic temperature below −400° C. at a pressure of at least 500 bar, distributed by the discharge orifice of at least one nozzle for distributing the jet of liquid nitrogen, characterized in that at least a portion of the distributing nozzle is protected by a resistant material having a hardness of at least 7 on Mohs' scale.

Depending on the particular case, the method of the invention can comprise one or more of the following characteristics:
said resistant material has a hardness of at least 8 on Mohs' scale,
the nozzle has a surface coating of said resistant material deposited externally on at least a portion of the nozzle wall,
the coating layer has a thickness between 2 and 50 μm, preferably between 5 and 20 μm,
said resistant material is deposited on at least a portion of the external wall of the nozzle in the region of the bottom of the nozzle with the opening of the discharge orifice,
the nozzle wall is made entirely or partly of said resistant material,
at least the bottom of the nozzle with the opening of the discharge orifice is made of said resistant material,
the nozzle wall is protected by a protective shield made, wholly or partly, of said resistant material,
the nozzle wall is protected by a protective shield (6) made of stainless steel with a thickness less than 10 mm, preferably between 2 and 6 mm. This protective shield is sufficiently thick to be able to withstand an operating time greater than at least 20 hours without having to be replaced,
the material is selected from tungsten carbide, boron carbide, cubic boron nitride, titanium carbide, silicon carbide, alumina and corundum,
during distribution of the jet or jets of nitrogen under pressure, the distance D between the bottom of the nozzle, measured at the level of the discharge orifice of the nozzle, and the surface to be cleaned is less than 20 mm, preferably between 5 and 15 mm, more preferably less than or equal to 10 mm,
the liquid nitrogen is at a cryogenic temperature below −150° C., preferably between −155 and −165° C.
the liquid nitrogen is at a pressure of at least 1000 bar, preferably between 2800 and 3500 bar,
a device for distributing liquid nitrogen is used that is equipped with several nozzles, each delivering one jet of liquid nitrogen,
the nozzles are arranged on a rotating or oscillating distributing head.

The invention will now he explained in more detail referring to the appended drawings, where:

FIGS. 1 to 4 propose embodiments of a nozzle usable in a method of pickling or descaling according to the invention,

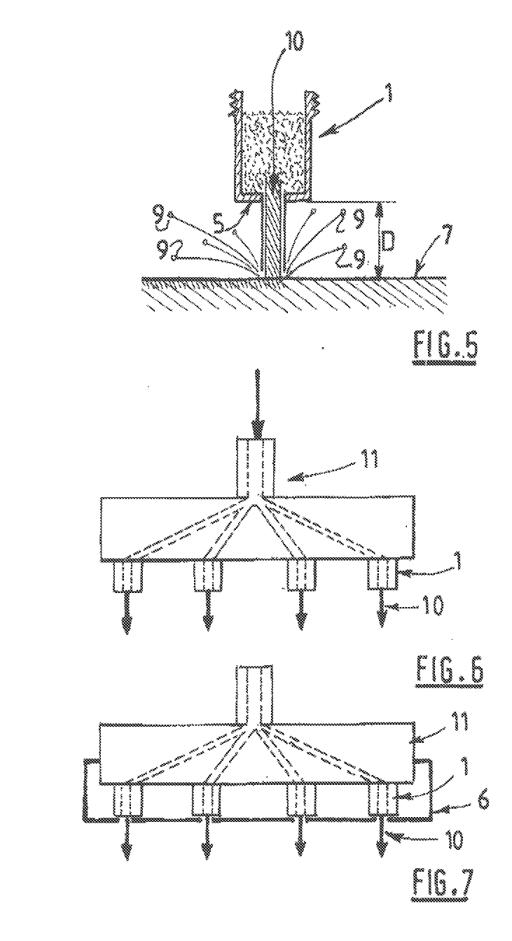

FIG. 5 illustrates the application of the method of pickling or descaling according to the invention,

FIG. 6 illustrates the operating principle of a device for pickling or descaling according to the prior art, and

FIG. 7 shows the device from FIG. 6 equipped with a Protective shield according to the embodiment in FIG. 4.

According to the invention, in order to carry out pickling or descaling of a concrete surface 7, a device for distributing liquid nitrogen under pressure is used, which is equipped with one or more, preferably several nozzles 1, each suitable for and designed for delivering, via their discharge orifice 2, a jet of liquid nitrogen at very high pressure, i.e. typically at a temperature of the order of −150° C. to −200° C. and at a pressure between 1000 and 5000 bar.

The problem that arises is to avoid or minimize wear of the nozzles 1 caused by the projection 9 of debris and other constituents of the concrete 7, during the actual pickling or descaling by means of the jet or jets 10 of liquid nitrogen, as illustrated in FIG. 5, and moreover wherein, during distribution of the jet or jets 10 of liquid nitrogen under pressure, the distance D between the bottom 5 of nozzle 1, measured at the level of the discharge orifice 2 of the nozzle, and the surface 7 to be cleaned or descaled is generally less than 20 mm, typically between 5 and 15 mm, and often less than or equal to 10 mm,

For this purpose, according to the invention, all or part of distributing nozzle 1 is protected by means of a resistant material having a hardness of at least 7 on Mohs' scale, advantageously of at least 8 on Mohs' scale.

As examples, the resistant material can be tungsten carbide, boron carbide, titanium carbide or silicon carbide, cubic boron nitride, alumina or corundum. In all cases, a material will be used having a hardness greater than or equal to that of concrete (between about 7 and 9 on Mohs' scale) and in particular greater than that of stainless steel (less than about 7 on Mohs' scale) so as to minimize the erosion caused by the impacts of concrete debris on the external wall of the nozzle or nozzles 1.

According to a first embodiment illustrated in FIG. 1, the wall 3 forming nozzle 1 can be made entirely of said resistant material.

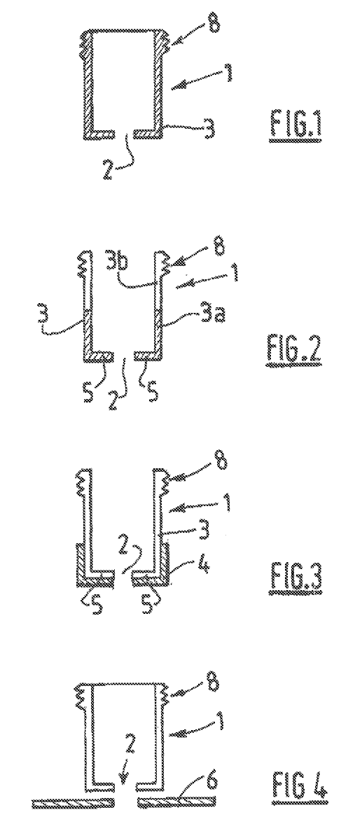

According to a second embodiment illustrated in FIG. 2, just a portion 3a of wall 3 forming the nozzle 1 can be made of said resistant material. In this case, it is only the lower portion 3a of nozzle 1 that is made of the resistant material, as this is the most exposed to the projections of concrete debris 7 and to the resultant wear. In contrast, its upper portion 3b, by which the nozzle 1 is joined to the device (not shown), for example by the screw-thread 8, can be made of a material that is less resistant, such as stainless steel.

According to a third embodiment depicted in FIG. 3, the nozzle 1 is protected by a surface coating 4 of said resistant material deposited externally on at least a portion of wall 3 of nozzle 1. In this case, it is important that at least the region of the bottom 5 of the nozzle with the opening of the discharge orifice 2 is protected, as this, as already mentioned, is the region most exposed to the projections of concrete debris. The rest of nozzle 1 can instead be made of a less resistant material, such as steel stainless steel for example. The coating layer 4 of resistant material can be deposited on the external surface of the wall 4 by a conventional deposition technique, notably by CVD, PVD, PCVD, PECVD, by electrodeposition, by an electrochemical technique.

The coating layer 4 can have a thickness between 5 and 50 μm.

According to a fourth embodiment illustrated in FIGS. 4 and 7, nozzle 1 can also be protected by a protective shield 6 that is some distance from the external surface of nozzle 1. This shield 6 is equipped with one or more orifices for passage of the jet to allow the jet or jets of liquid nitrogen to be propelled toward the surface 7 to be cleaned, preferably orifices for passage having a diameter less than 1 mm but greater than that of the discharge orifices 2 of the nozzles 1. This shield 6 can be interchangeable and therefore can be replaced once it is damaged. It has for example a thickness between 1 and 5 mm. This shield 6 can itself simply be made partly or coated with a resistant material or can be made of said resistant material completely.

1-10. (canceled)

11. A method for pickling or descaling a concrete surface employing at least one jet of liquid nitrogen at a cryogenic temperature below −100° C., and at a pressure of at least 500 bar, distributed by the discharge orifice of at least one nozzle for distributing the jet of liquid nitrogen, wherein at least a portion of the distributing nozzle is protected by a resistant material having a hardness of at least 7 on Mohs' scale.

12. The method of claim 11, wherein said resistant material has a hardness of at least 8 on Mohs' scale.

13. The method of claim 11, wherein the nozzle has a surface coating of said resistant material deposited externally on at least a portion of the wall of nozzle.

14. The method of claim 11, wherein said resistant material is deposited on at least a portion of the external wall of nozzle in the region of the bottom of the nozzle with the opening of the discharge orifice.

15. The method of claim 11, wherein the wall of nozzle is made entirely or partly of said resistant material.

16. The method of claim 15, wherein at least the bottom of the nozzle with the opening of the discharge orifice is made of said resistant material.

17. The method of claim 11, wherein the wall of nozzle is protected by a protective shield made of said resistant material or made of stainless steel coated with said resistant material.

18. The method of claim 11, wherein the wall of nozzle is protected by a protective shield of stainless steel with a thickness less than 10 mm.

19. The method of claim 11, wherein the material is selected from the group consisting of tungsten carbide, boron carbide, titanium carbide, silicon carbide, cubic boron nitride, alumina and corundum.

20. The method of claim 11, wherein during distribution of the jet or jets of nitrogen under pressure, the distance between the bottom of nozzle measured at the level of discharge orifice of the nozzle and the surface to be cleaned is less than 20 mm.
